(19) United States
(12) Patent Application Publication
(10) Pub. No.: US 2003/0231556 A1
(43) Pub. Date: Dec. 18, 2003

(54) Display system to denote time and other values

(76) Inventor: Robert Thomas Peterson, Hammond, IN (US)

Correspondence Address: Robert Thomas Peterson, 6233 Garfield Avenue, Hammond, IN, 46324-1122, US

(21) Appl. No.: 10/412,765

(22) Filed: Apr. 14, 2003

Related U.S. Application Data
(60) Provisional application No. 60/388,499, filed on Jun. 14, 2002.

(51) Int. Cl. G04C 17/00; G04B 19/00; G04B 25/00

(52) U.S. Cl. 368/223

(57) ABSTRACT

A system for denoting time and other values by electronic or equivalent displays. Hours are indicated display pattern created out of centrally located displays that, in the aggregate, form the image of a six pointed star. Minutes are indicated by two sets of displays. The primary set appears on the perimeter of the display area, in correspondence to analogue locations, and represents 5 or 10-minute time spans. Complementary minute indicators appear either within or near the primary minute indicators, or outside the primary indicator displays, or inside the hourly indicator. These complementary indicators specify the time to the nearest minute within a primary minute span. Seconds are indicated by blinking elements of the minute indicator displays. The system may be used also to indicate such values as radio band location, time elapsed, date, CD track and operational mode.

Acronyms Used

Acronyms used frequently in this application are:

HI—Hourly Indicator

PMI—Primary Minute Indicator

SBS-PMI—Standard Bisected Primary Minute Indicator

CMI—Complementary Minute Indicator

5MI—5 Minute Display:

SI—Seconds Indicator

### CROSS-REFERENCE TO RELATED APPLICATIONS

Not applicable.

### BACKGROUND

1. Field of Invention

The foremost application of this invention is the denotation of numeric values for electronic display timekeeping devices, such as clocks, watches and timers. This invention may also be used, however to denote other values that are used in devices such as radios, compact disk players, calendars, or combinations of such items with themselves and/or with timekeeping devices. When used multi-functionally, the system may also be used to indicate the current mode of operation

2. Description of Prior Art

The representation of time that is based on a 24-hour cycle is currently dominated by two systems—the analogue and the digital systems. Both of these systems rely on numeric values. In the analogue system, these values are pointed to. In the digital system, they are simply stated. While the digital systems are cheaper to produce, and may also be easily applied to a variety of functions, such as denoting radio band location, etc., analogue systems remain popular, probably because of a greater intuitive visual appeal. As one writer has explained it, “From the 14^{th} century to the present, mankind has developed an understanding of time based on a clock dial—a surface that shows the relationship of time past to time to come.” “the digital readout . . . presents time without a context, a reading of the moment only, with no sense of past or future.” (Mary Alice Brennan-Crosby, Reader's Digest, November '85)

Moreover, digital systems denote time not by traditional number images themselves, but by straight-line approximations of them—crude images that are found nowhere else except in such display systems.

Moreover, indicating seconds with any degree of precision is not really practical with digital timepieces. To do so would require the addition of 14 additional displays that would be more prominently located than the minutes displays, which is usually what users are more interested in.

What has not been developed is a system that successfully combines the relatively low production expense and multi-functionality of digital timepieces to the intuitive aesthetic appeal of analogue timepieces. Presumably there have been non-patentable attempts to do so, simply by creating an electronic display system that shows hour and minute hands instead of digital displays. But this comes off only as a weak substitute for the real thing. Aside from digital systems, there has been no commercially successful systems that exploit the distinctive capabilities of electronic displays.

One system that attempted to do so was one invented by Russell Bik, in U.S. Pat. No. 5,228,013 (1993). Bik utilized 7 display elements, in conjunction with pulses or color changes, to indicate time to the nearest minute. While indicating that there were several ways to code such a system, Bik provided an example as follows: A central display indicates time to the nearest three hours. Periodic pulses (or blinks) indicate exactly which three hours. If, for example, there are periodically 2 pulses, the time is the second 3-hour segment of a 12-hour cycle—that is, from 3 to 6 o'clock. The next set of three displays further specifies the time by the number of displays that is illuminated or not. Thus, if one display is illuminated, the time is between 3 and 4 o'clock. These displays also pulse, up to 4 times, to further specify the time to a 15-minute span. The second and last set of three displays further specifies, by illumination, the appropriate 5-minute span within the 15-minute one. The time in this set is further specified, to the minute, by 1 to 5 pulses that periodically recur. Bik adds that, instead of pulses, color changes could be used. There is no provision for seconds.

Bik's system is one that completely relies on “complementary indicators”—that is, indicators that specify time within the context of a prior indicator. The concept itself is not novel, the minute hand of an analogue system is a complementary indicator to the hour hand, and the timekeeping system it denotes itself depends on complementary sub-divisions of the time from hours to minute to seconds. Bik's system was different from the analogue system in that the time values of his indicators were entirely independent of their location on the dial face.

The present invention also relies on complementary indicators, but not to the same extent. For a 12-hour cycle, Bik uses 5 tiers of such analogue-independent indicators; for the same time values, the present system uses, depending on the variation, two to three. The present invention uses fewer because, in contrast to Bik, it is partially an analogue system.

The purpose of the Bik invention, among other things, was to enhance the aesthetic appeal of clocks. Under that invention, art was to be created around, and integrated with the displays. Under the present invention, the art is in the display patterns themselves.

Another U.S. Pat. No. 5,748,568 by Hal Harrison, is a display system combining digital and analogue features. In it, linear radial minute display indicators are superimposed over large digital hourly displays. Additionally, the other sections of the dial face are also broken up into displays and illuminated cumulatively as the minute indicators progress. These additionally displays serve no timekeeping function, but, similar to the Bik concept, are included to enhance aesthetic appeal.

A patent by Anthony Graves, U.S. Pat. No. 6,198,698, relies on no extraneous additions, and is a purely analogue system, but with no hour or minute hands per se. In it, hours are indicated by illuminating the appropriate hour figure on the perimeter; minutes are indicated by a pie chart fashion which by which, at the end of the hour, would illuminate the entire dial face. There appears to be no provision for seconds.

Closer systems to the present invention include William C. Crutcher's U.S. Pat. No. 4,121,415. In it, there is a central digital indicator for hours; minutes are indicated by displays that appear on the 0perimeter at 5-minute intervals. Another is Fridolin Wiget's U.S. Pat. No. 4,367,959, in which he created a system that disposed of the digital hourly indicators and utilized 48 indicators lining the perimeter of the dial face. Different values were indicated by means of displaying a single display and displaying abutting ones. Another is Charles S. Coster's U.S. Pat. No. 4,742,501, which includes the hourly digital display and 60 perimeter displays. Of these, Coster—having both a central flexible hourly indicator and analogue-type minute displays—seems closest of these to the present invention. The distinctions are that the present invention, while using a digital process to create a central hourly indicator, does not use it to create a digit, but rather directional or symbolic patterns. For minutes, it uses perimeter displays, but, in the preferred embodiment, only 6, supplemented by 10 or fewer complementary displays. This allows the indicators to be larger and thus more visible; it allows them to be fewer, and thus less expensive to produce.

The closest work to the present system appears in my own design U.S. Pat. No. 280,803. Here, the displays of the centrally-appearing indicator form, in the aggregate, a star image that is the same as possible central indicators for claims I and 4 of the present invention. There are, however, other central indicators in claims 1 and 4—such as those based on “flat,” “sharp,” “sharp/bent line,” “stretched,” or “outline” star frameworks—that are arguably not anticipated in the central image appearing the design patent. Such images, in other words, are arguably insufficient prior art for the claims of the present invention, ones that do not claim specific images, but rather a system.

In the remaining claims of the present invention, the central indicator framework, having a hollow or “dark” core, is distinct from the earlier design patent as well. Since this framework creates differently-appearing central indicator patterns, this distinction alone, for a design patent prior art, would be sufficient to distinguish it. The dark core also, however, makes possible the inclusion of a central AM/PM indicator option, and the inclusion of central complementary minute indicators. At the same time, the hourly pattern indicators under it use, on balance, less electrical power.

Moreover, the system itself is different in all its claims from what is implied by the design patent images, that is, an analogue system. With respect to minutes, the present invention is, for the most part (see exception at ¶0066), only partially analogue—a modification that greatly reduces the number of displays required.

Finally, the earlier design patent, entitled “Dial Face for Electronic Timepiece,” was restricted solely to timekeeping. Because of its innovative minute-keeping system, the present invention is much more suitable for other purposes as well.

### SUMMARY

The present invention utilizes electronic displays to create an electronic display framework from which a variety of hourly indicator patterns may be created, to create a minute indicator framework that is part analogue and part complementary and from which patterns harmonious to the hourly indicator may be created, and a second indicator that is part analogue and part complementary. The foregoing displays may also denote values other than timekeeping ones.

### OBJECTS AND ADVANTAGES

Accordingly, several objects and advantages of the present invention are to create a system:

(a) that combines the low production costs of digital systems with the intuitive and aesthetic appeal of analogue systems;

(b) that has the versatility of digital systems to be used for other purposes, such as radio band indicators, CD track monitors, calendars, and so on;

(c) that has a versatility in which, in contrast to digital systems, the various modes of use are recognizable on their face;

(d) in which some minute display elements may, for the purposes of visual balance, be coordinated with hourly display elements;

(e) in which the visual appeal of which may be enhanced by recurrent images;

(f) in which seconds may be unobtrusively displayed the nearest 5 seconds;

(g) in which the hourly display elements may be adjusted to harmonize with the time of day;

(h) that permits a distinctive and aesthetically pleasing timer function;

(i) in which hourly indicators and complementary indicators may appear in a variety of patterns;

(j) in which the display indicators may be modified to the wishes of the customer;

(k) that creates brighter, and thus more visible images than do analogue systems, and

(l) that lends itself to the creation of an angular cover suggestive of a diamond.

### DRAWING FIGURES

In the drawings, FIGS. 1 to 10A relate to claims 1 to 10, respectively. FIGS. 10B and 10C relate to claims 11 to 13, together. Generally in all the drawings, related figures have the same number but different alphabetic suffixes. FIGS. 23A and 23B help provide a general overview, and are otherwise not referred to. All figures are presented as examples of the system, and not intended, in themselves, to represent the system.

FIGS. 1A to 1M are subgrouped as following:

FIGS. 1A to 1F show frameworks for indicators described in part (a) of claim 1. For the purposes of this application, the frameworks are termed as “basic,” “flat,” “sharp,” “sharp/bent line,” “stretch,” and “outline,” respectively.

FIGS. 1G and 1H show an “outline” framework with “zebra” and “snowflake” embellishments.

FIGS. 1I and 1J show frameworks for indicators described in part (b) of claim 1.

FIGS. 1K and 1M show examples of combined frameworks described in parts (a) and (b) of claim 1.

FIGS. 2A to 2E are sub-grouped as following:

FIG. 2A showsf a variation described in claim 2.

FIGS. 2B to 2E show, in isolation, additional examples of the described variation. FIG. 2C includes lines that not meant to actually appear; these lines simply illustrate how, in accordance with claim 2, the framework in the following figure, FIG. 2D, is arrived at.

FIGS. 3A to 3C show, in partial isolation, examples of the additional display element described in claim 3.

FIGS. 4A to 4C show variations with examples of the additional display elements described in claim 4.

FIGS. 5A to 5B show variations described in claim 5.

FIG. 6 shows a variation described in claim 6.

FIGS. 7A to 7C show variations described in claim 7.

FIGS. 8A to 8C show, in partial isolation, examples of the additional display element described in claim 8.

FIGS. 9A to 9C show variations described in claim 8 and 9. Regarding claim 8, the centermost figure represents a supplemental minute indicator; regarding claim 9, it represents a supplemental hourly indicator.

FIG 10A shows a variation described in claim 10.

FIGS. 10B and 10C show, partially and in partial isolation, the additional displays described in claims 11 to 13.

FIGS. 11A to 11I show, in isolation, directional or symbolic indicator patterns.

FIGS. 12A to 12C show, in isolation, a possible depiction of minute and second values for :28:05 to :: 10; :28:35 to ::40; and :24:35 to ::40 after the hour, respectively.

FIGS. 13A to 13C show, in partial isolation, possible complementary minute indicator, or CMI, patterns that indicate the fourth value of a primary minute indicator, or PMI, span.

FIGS. 14A to 14F are subgrouped as follows:

FIG. 14A shows, in isolation, a hex-ring CMI framework divided into 6 shiftable pairs of display elements.

FIGS. 14B and 14C show different pair images that can be made from the framework shown at FIG. 14A.

FIG. 14D shows, in isolation, an hourly indicator, or HI, with a CMI in balance with it. FIG. 14E shows and HI with a CMI that is not in balance.

FIG. 14F shows the use of a shiftable CMI display pair to maintain a balance with the HI.

FIGS. 15A to 15D show, in isolation, four different configurations for primary minute indicators, or PMIs.

FIGS. 16A and 16B show, in partial isolation, possible different patterns to indicate the third value of a hex-ring cycle.

FIGS. 17A and 17B show, in partial isolation, the third and the eighth values, respectively, of a 10-minute hex-ring cycle that uses a five-minute indicator, or 5MI.

FIGS. 18A to 23 show :03, :07, and :12 after the hour, respectively.

FIG. 19A shows a “full display” variation, in which there are no non-display areas. FIGS. 19B and 19C show possible covers for such system that could be employed in order to create a diamond-like effect.

FIGS. 20A to 20D show possible configurations to show the radio band locations of 880-AM; 88.3-FM; 880-AM and 88.3-FM, respectively.

FIGS. 21A and 21B shows a possible timer mode pattern representing about 2 thirds, and 1 half of the set time having elapsed, respectively.

FIG. 22A shows a possible display configuration to show August 26. FIG. 22B shows a possible configuration to show track 26 on a CD player.

FIGS. 23A and 23B show variations labeled with acronyms.

FIGS. 24A to 24F are abstracts of central indicator patterns possible under the claim 1 framework. The pattern of 24C and 24D are possible only under an “outline” variation of the framwork. The figures are grouped into 3 sets of odd-even hourly pairs.

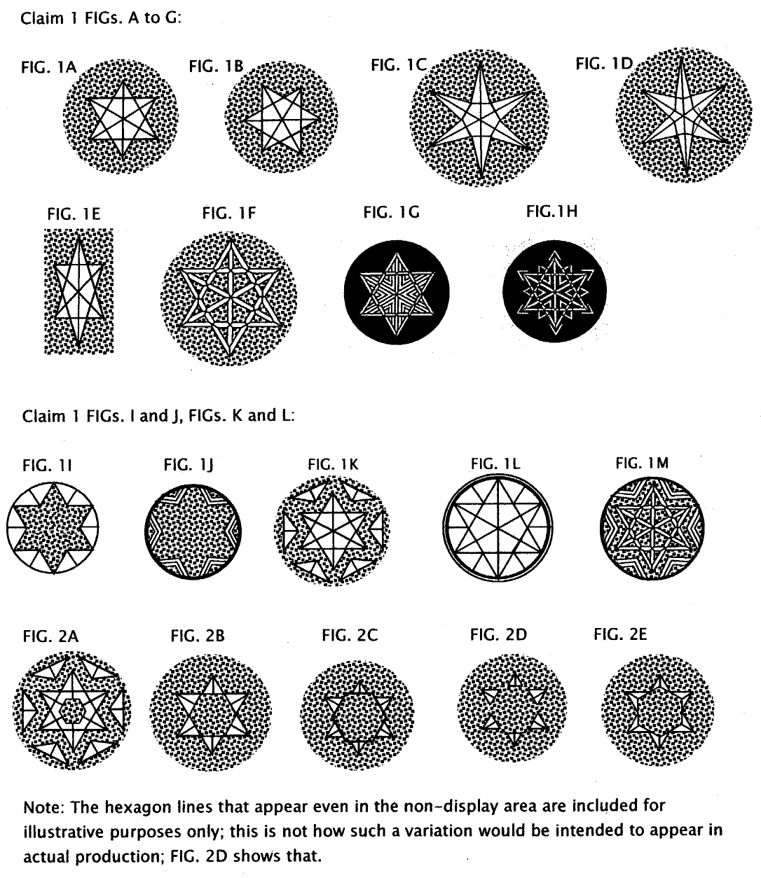

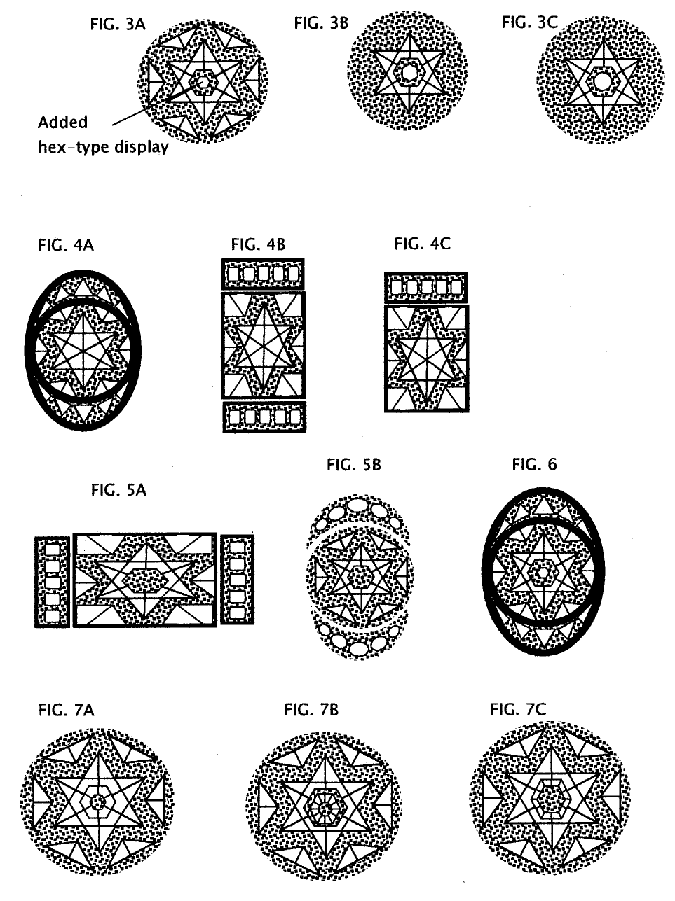

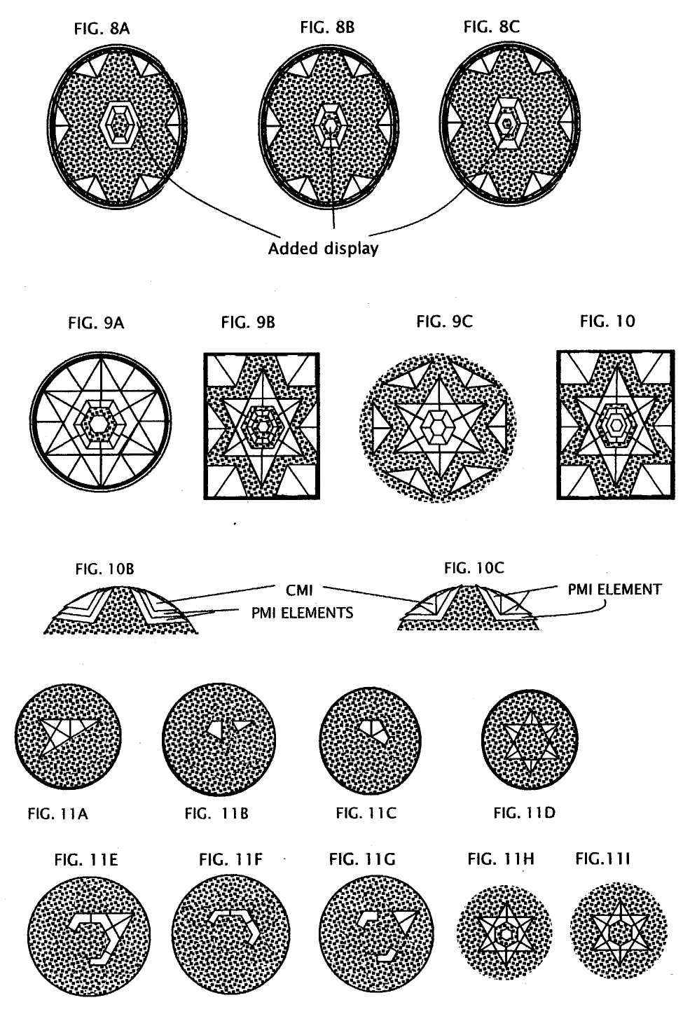

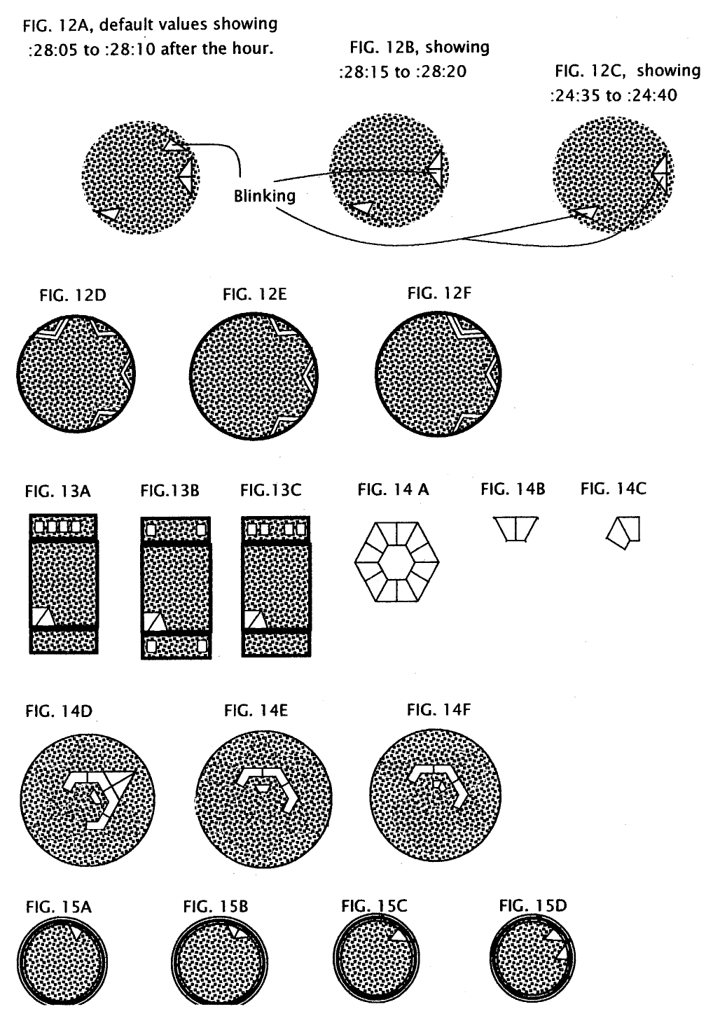

### ACRONYMS AND TERMS

HI—Hourly Indicator. (See ¶s 0058-59.)

PMI—Primary Minute Indicator. (See ¶s 0061-62.)

SBS-PMI: Standard Bisected Primary Minute Indicator. (See ¶0062-63.)

CMI—Complementary Minute Indicator. (See ¶s 0065-69.)

SI—Seconds Indicator. (See ¶0070.)

5MI—5 Minute Indicator. A 5MI may also be described as a cycle indicator for a CMI hex-ring. (See ¶s 0085-86.)

COMPLTD-SPN: Completed time Span. (See ¶0063.)

CURR-SPN: Currently operating time Span. (See ¶

Illuminate: In order to prevent confusion with the noun and verb usages of “display,” “illuminate” is used as a substitute for the verb “display.” It does not necessarily actually mean that the display is illuminated. In some uses of the system, it is the background, non-display area that may be illuminated. In such systems, making an indicator pattern visible would actually require a non-illumination of its elements. For purposes of this application, however, making such elements visible will always be referred to as “illumination.”

Display: The use of this term is conventional, except that it may also refer to a group of displays that illuminate simultaneously so as to create the effect of a single display.

### DESCRIPTION

Operation of the Timekeeping Mode

Hourly Indicators—All Claims

The display elements of the framework are selected in a way to form shapes that, either directionally or symbolically, indicate the time. For example, FIGS. 11A and 11B show a directional indicator pointing to 2 O'clock or the number 2. FIG. 11C shows one pointing to 1 O'clock. FIG. 11D shows a symbolic indicator that could be used to indicate any hour or number, but preferably one that could be easily associated with such image, such as 12 midnight. FIGS. 11E and 11F show directional indicators that use a claim 2 or 3 variation of the HI. Since there are a variety of options to show a single hour, AM or PM, or daytime or nighttime, might also be indicated by the HI option chosen. For example, FIG. 11E could represent the daylight hour of 2 PM, while FIG. 11G might represent the nighttime hour of 2 AM. Also, a dimmer or different color might be produced to distinguish the different AM/PM or daylight/nighttime representation.

Hourly Indicators—Claims 3, 6, 9, 10

In these claims 10 there is also an additional way to show AM/PM, that is, with a display indicator added for such purpose. As with the HI option, this display could—to enhance the imagery that the system produces—be set to indicate not AM and PM, but rather daylight and nighttime hours. For example, its illumination could indicate 6 AM to 6 PM for daylight hours, and its non-illumination could represent 6 PM to 6 AM for nighttime hours. In this way, the imagery that the system produces would more closely correspond visually to the actual day cycle. While, of course, any AM/PM indicator in use today could be modified in such a way, the systems they operate under do not, as does the present invention, produce the imagery that would justify such a modification in the first place.

In keeping with such imagery, FIG. 11H shows a possible pattern to indicate the noon hour, and 11I shows the same pattern, with the AM/PM indicator not illuminated, to indicate the midnight hour.

Recurrent Images—All Claims

Another, and possibly the most visually appealing way to indicate AM/PM would be through the use of periodically recurring images. Each time a minute was complete, for example, an image such as the one in FIGS. H and I may flash briefly to indicate AM or PM. Or they might be included for other purposes, such as mode identification, or simply to enhance visual appeal.

Minutes and Second Indicators—All Claims

All claims represent minutes by the use of Primary Minute Indicators (PMIs) in conjunction with Complementary Minute Indicators (CMIs). PMIs are analogue-based displays or groups of display elements, in the aggregate, indicate time to the nearest 10 minutes. In some variations, display elements of the PMI may illuminate separately to specify the time more precisely. CMIs are primarily not analogue based, and further specify the PMI time to the nearest minute.

Variations of PMIs include three categories: “single display,” “bisected,” and “layered” PMIs. Single display PMIs utilize a single display; bisected and layered utilize 2. Bisected PMIs are either “standard” or “modified.” For PMI purposes, standard bisected PM's (SBS-PMIs) illuminate both elements as a single unit; their division into elements is simply so that the elements can more easily be used for other purposes as well, such as indicating seconds. Modified bisected PMIs, in contrast, have elements that can illuminate separately, and add up to a value of 10 minutes only in the aggregate. Modified bisected PMIs are either “single-element,” “2-stage,” “3-stage,” or “standard/split” modifications, discussed below, beginning at ¶0079.

There are three possible ways of reading SBS-PMIs: (a) the indicator represents a completed 10-minute span, (b) it represents the 10-minute span in which the CMIs are currently operating, or (c) it represents a completed value indicated directionally by the PMI display figure. Thus, the SBS-PNI shown in FIG. 12A would represent, under (a), 20 completed minutes; under (b), 10 completed minutes, and under (c), 15 completed minutes. For purposes of this application, the first two alternatives—referred to hereafter as COMPLTD-SPAN and CURR-SPAN—will be used. The default reading will be value representation alternative will be COMPLTD-SPAN.

Layered PMIs, which are created to show PMI time to the nearest 5 minutes, are thus a kind of modified PMI; the difference is that their elements are divided in a way in which time progresses within the 10-minute span not by visual sequence, but by visual aggregation. One element, in other words, is, in the preferred embodiment, larger than the other; it represents 10 minutes, while the smaller represents 5.

CMIs fall into four categories: “economy,” “bar,” “hex-ring” and “embedded” CMIs. The names of the last three suggest the preferred embodiment of such CMIs, but they are not restricted to such forms.

Economy CMIs use single elements of SBS-PMIs. The value of the CMI is indicated by the analogue value of its furtherest clockwise position. A CMI with its clockwise-most point at 6 o'clock, in other words, would call for the addition of 6 minutes to the PMI value. This is the only CMI variation, referred to at [0016], that regularly relies completely on analogue positions, although not in the traditional manner.

Bar CMIs appear separately from the other displays, and, in the preferred embodiment, outside the dial face proper. They do not necessarily appear in the form of a bar.

Hex-ring CMIs are 6 display or 6 pairs of such units that, combined, form a hexagonal-type ring or figure that appears inside the “dark” or hollow star HI that first appears in claim 2. Similar to bar CMIs, such ring or figure need not be precisely hexagonal. Elements of hex-ring pairs combine differently in order to coordinate better with the HI.

Embedded CMIs are 6 displays that appear near or embedded within their respective PMI displays.

Seconds Indicators: There are no displays devoted exclusively to indicating seconds. These are indicated by the use of PMI elements for 5 or 10 seconds at a time, and in correspondence with analogue location values. The display may blink with each second to distinguish or farther distinguish such usage from other usages. See example at FIG. 12A. Sometimes the SI usage will converge with PMI usage. In such cases, the SI blinking prevails. See FIG. 12B.

Claims 1 to 3

Here, economy CMIs (see ¶0066) are used. Economy CMIs are an alternative to the preferred variation of embedded CMIs.

Sometimes economy CMIs will converge with PMIs. When this occurs, the indicator representing the shortest time—the CMI—over its own location, prevails. See FIG. 12C. FIGS. 12D to 12F show, in isolation, the application of economy CMIs under a layered PMI variation. The times are :03; 07; and :12, respectively. The first display in 12E is a 5 minute indicator by virtue of the fact that that is no preceding 10-minute PMI.

Claims 4 to 6

Under the preferred embodiment here, 10 bar CMIs (see ¶0062) are used. In conveying time or other values, these displays are not restricted to an ordinal appearance, but may appear in any pattern. For example, the fourth CMI value after the PMI value of :40 may be represented as shown in the examples at FIGS. 13A through 13C.

In alternative embodiments, modified PMIs may be used that represent only a 5-minute span, thus necessitating only 5 additional displays to serve as CMIs. 10 displays are preferred, however, on the ground that time computation would be simpler.

Whether 10 or 4, if the PMI/CMIs operate under COMPLTD-SPN, then only 9 or 4 displays are actually necessary, respectively. This is because, under that operation, at the completion of the 10^{th} or the 5^{th} minute, the system would move to the next PMI, thus making such CMI display unnecessary. Nevertheless, 10 CMIs are preferred over 9, since this would permit the patterns of the two sets of CMI to be consistent with each other, and also would arguably provide better pattern alternatives.

Claims 7 to 10

Here, hex-ring CMIs (see ¶0068) are used. The preferred embodiment utilizes 6 pairs, rather than simply 6 displays. With the pairs, them, two different types of CMI images may be created. See, in isolation, an example of hex-ring framework and possible CMIs under it at FIGS. 14A through 14C.

The use for these options is shown in FIGS. 14D to 14F. 14D shows a CMI that is in “natural” balance with the HI. 14E shows one that is in imbalance. 14F shows how “shiftable pairs” of CMI displays can correct the imbalance.

Claims 7 and 9

Under an alternative embodiment that utilizes SBS-PMIs with hex-ring CMIs, there are insufficient CMIs to cover the 10-minute span. To break up the hex-ring pair so that 10 of them could be used as CMIs would create very small CMIs, and would create imbalances with the HI. Instead, to address this problem, the operation of the much larger PMIs are modified. There are several options, including the “single element,” the “2-stage,” the “3-stage,” and the “standard/split” operational modifications.

“Single-element”: SBS-PMI elements appear separately, each representing a current or completed 5-minute span. Thus, under default PMI values, FIG. 15A would represent :05 plus CMI and SI values and FIG. 15C would represent :10 plus such values. Under this modification, the 6-element CMI hex-ring is more than sufficient.

“Two-stage”: The first clock-wise element of a SBS-PMI operates in the same fashion as in the single-element modification. For the next 5-minute span, however, instead of the display of the other single PMI element, both PMI elements as in a standard PMI—are displayed. See FIG. 15B. The purpose of this modification over the prior one is to create more balanced and appealing image by featuring the combined PMI elements half of the time. The disadvantage is that it is not consistent in its approach, and so can be confusing.

“3-stage”: The SBS-PMI is split into its elements and is used with such elements. Thus, during a 10-minute span, there is not one, but 3 possible PMI configurations—the first clock-wise element, the combination of both elements, and then the second clock-wise element. See FIGS. 15A to 15C. The 10-minute PMI span is divided among these three configurations.

Like the 2-stage modification, the purpose of this modification is to feature the combined PMI elements image—that is, stage 2. Use of the default value representation, however, would work against that purpose. Say, for example, we assign time values to the three configurations of 2, 6, and 2 minutes of the 10-minute span respectively. Under the default value representation, these values would represent completed minutes. This would mean that for the first 2 minutes, the first stage would not appear at all. The second—and most appealing stage—would not appear until 8 minutes had elapsed. To remedy this, we use a CURR-SPN operational mode. The CMIs, in other words, would be added to the lowest value of the PMI stage. In this way, each stage would display for the full number of minutes assigned to that stage.

“Standard/split” modification: Here the PMI appear as standard PMIs and as split PMIs. Split PMIs are pairs of PMI elements that do not form a standard PMI. Instead, split PMIs are formed by single elements of two standard PMI that abut each other. The abutting elements create the split PMI. See FIG. 15D. The point of abutment is the PMI time value. Thus, in FIG. 15D, the PMI value is 10 minutes after the hour. Under this modification, the location of the abutting elements would represent the completed time.

In any of the above PMI operational modifications, the CMIs, as with other operational approaches, need not, in conveying a value, be restricted to any particular pattern or value assignment. For example, in the 3-stage modification, if the first stage represents only 2 minutes, and the time is at the first minute, such information need not be indicated with simply a single CMI. It could be represented by 3 CMIs—on the ground that that would represent the first half of the 2-minute stage. These could appear in any pattern. See FIGS. 16A and 16B.

Claims 8 and 10

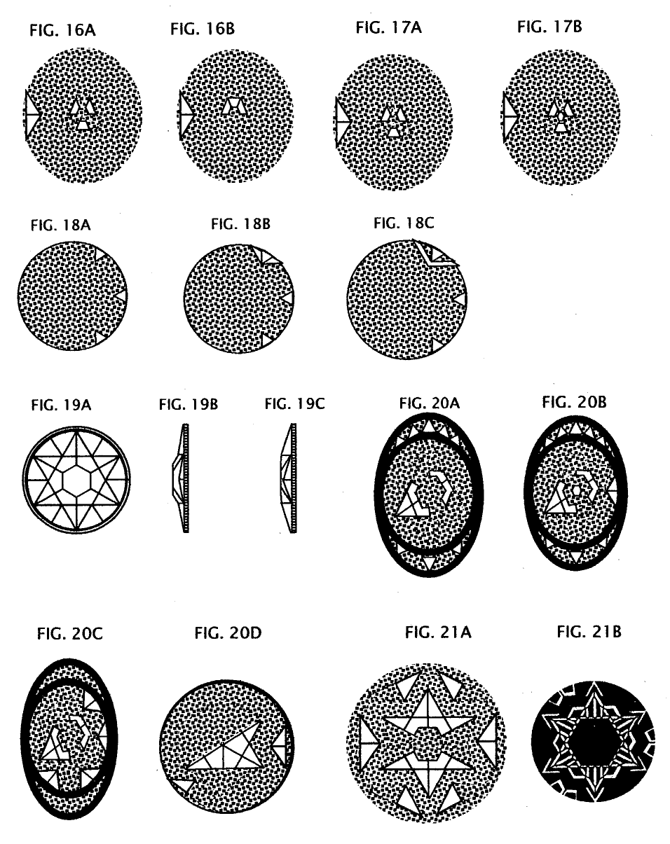

In the preferred solution to the shortage of hex-ring CMIs for the 10-minute span of a SBS-PMI, a new centrally-located display indicator is added. With this, the CMIs can go through a 5-step cycle twice during each 10-minute span, with the new display indicating the cycle. Non-illumination of the display, for example, could indicate the first cycle; illumination could indicate the second one. Thus, FIG. 17A would represent :48 and FIG. 17B would represent :53 after the hour.

Since each stage is 5 minutes, this display in effect represents 5 minutes; for this reason it is designated simply as a 5MI—that is, a 5-Minute Indicator.

If a system had both a 5MI and an AM/PM indicator, and both these displays were solid figures, they would overlap. To remedy this, one or the other may be a single-element ring display that encircles the other, or even encircles the hex-ring as well. Since there are other options to indicate AM/PM, however, and since the hex-ring system is probably best suited for devices like wristwatches, in which an AM/PM indicator is not as important as it would be in a clock with a wake-up alarm function, this problem will probably rarely arise, if at all, in any case.

Claims 11 to 13

Perhaps even more suitable to small dial faces are variations using embedded CMIs (see ¶0069). Under their preferred embodiment, they are embedded within the parameters of layered PMIs. Under it, the preferred operation is as follows: the first minute of the first PMI span is shown by a single CMI. The next minute is shown by the addition of the next clockwise CMI, and so on, until the completion of the first five minutes of the span is shown by the illumination of the inner PMI layer. For increased visibility, and to help distinguish it from a PMI-based SI, the CMI embedded with the PMI layer may be illuminated as well. The CMI cycle is repeated until the 10^{th} value of the span is complete. Then—unless it is the 6^{th} PMI span—the outer PMI layer, preferably in conjunction with the embedded CMI, for the same reasons cited above, illuminates. The inner PMI layer could illuminate as well, but it is not necessary. The displays continue to illuminate until the 5-minute layer of the next PMI illuminates. If it is the 6^{th} PMI—thus representing the end of the hour—the displays stop illuminating immediately at the end of their PMI span. See FIGS. 18A to 18C, in which the small triangular display is the embedded CMI; the 5-minute layer is split into two elements, and the 10-minute layer is a single element over both. Under the foregoing approach, FIG. 18A would indicate :03; 18B would indicate :07; 18C would indicate :12.

Claims 14 to 20

The primary difference between these claims and the foregoing ones is that the PMI is a single display. This creates a need for a 5MI in claims 19 and 20. These are alternative embodiments.

Diamond Imagery—All Claims

Variations in which the dial face is taken up completely by displays lend themselves to the creation of dial face cover that is angular rather than smooth, and which approximates the surface of a diamond. See FIGS. 19A to 19C, which shows such display system and two possible covers for it. In such a system in particular, all the displays might be illuminated and the time indicated by creating a different color in the appropriate displays.

Comparative Display Requirements

A digital system showing time to the nearest second uses 37 displays. (If seconds are indicated only by blinking colon, it is 25.) A claim 11 variation using solid displays (non-outline) that indicates time (without blinking) to the nearest 5 seconds uses 36. Of course, the HI displays are larger and so use more electricity. The particular HI patterns that are used may cause a greater usage as well. On the other hand, as noted above, in nighttime hours the present invention may revert to patterns that are more electrically economical, while still indicating the time.

If an outline HI is used, the number of displays required is 54. The displays are smaller however, and approximate in shape the digital displays that are being produced today. Again, the outline pattern can revert to nighttime patterns. During that time, at least, it would probably use less electricity than digital systems.

Operation of the Radio Band Indicator Modes

One of the advantages of digital timepieces (such as clock radios, in particular) is that the same displays can be used to indicate any numeric value. Traditional analogues, in contrast—even if they utilize electronic displays to create an analogue image—cannot easily do this because they are based on a 60-minute cycle. Thus, if one attempted to use an analogue to indicate AM radio band locations, it might show the location of 530 easily enough, simply in the same way it shows the time of 5:30, but it would be unable, in the same fashion, to show 570 or 880. It could be shown, of course, by equating minute with the second-digit value of the radio band, so that a location like 880 would appear the same as the time of 8:08. This, however, seems counter-intuitive, and provides on a small area in which to indicate the second digit.

Another possibility would be to have both the minute and the hour hand take their value from the hour location, and simply not utilize the last two hours. But this would work only for AM bands. For FM bands locations, having three digits, one would need to add a second hand indicator also. Since the second hand would not move as quickly, indeed, it would not move at all, as it would on an analogue timepiece, it would be confusing as to which hand was pointing to what.

The greater dispersion and internal distinctiveness of the claimed display systems, particularly those utilizing bar-CMIs, minimizes such difficulties. Take the bar-CMI system of claim 5. Since it has 10 CMIs, the AM-radio band location could be shown as in FIG. 20A. This basically equivalent to an analogue showing 8:08; here, however, the :08 displays cover a much larger area, and in a context of 10 values—the precise number of values needed.

As noted, FM bands require indicator for a third digit, as in 88.3. Typically, these digits are only odd numbers, that is .1, .3, .5, 7, and .9—values that, in the preferred star posture embodiment, happily correspond to standard PMI analogue hourly locations. Thus, standard PMIs are naturally suited to indicate such values. See FIG. 20B, showing the FM band location of 88.3 FM under such a usage. Should more locations be desired, single PMI elements or other modified PMI could be used. Use of the PMIs for this digit would also, in the interest of consistency, allow CMIs to be used to indicate the second digit in both the AM and FM bands. While of course one course reverse the operation so that PMIs represent the second digit and CMIs the third, or even HIs represent not the first, but the second or third, the HI-CMI-PMI sequence is the preferred operational embodiment for radio band indicators.

Similar to the way AM and PM can be distinguished in the timekeeping mode, there are, in the preferred embodiment, several ways in the radio mode to distinguish AM and FM. In AM, PMIs are dropped entirely; in FM, they are not. Particular modes could also be identified by the use of particular hourly patterns. Different modes might also be indicated by the use of different PMI modifications, such as “standard/split” PMIs, and/or by the use of cumulative use PMI displays, as in the example shown at FIG. 20C. Indicating the mode simply by the display appearance is an advantage the present invention has over digital systems.

In addition to bar-CMI variations, economy-CMI variations could indicate radio band locations as well. See FIG. 20D, showing how 88.3 FM could be represented. In such a case, the non-timekeeping mode might, if desired, be indicated by means of having the (in the timekeeping mode) HI displays, instead of the SI (or CMI) displays, blink. Hex-ring-CMI variations with a 5MI could be used as well, but, because of the small size of the CMIs, would be ill-suited to such a purpose. Since neither the “economy,” the “hex-ring,” or the “embedded” CMI variations would translate as easily into a tens-based system, the “bar-CMI” would be the preferred embodiment for alternative use as a radio band location indicator.

Other Operational Modes—Timer, Calendar, CD Track Indicator

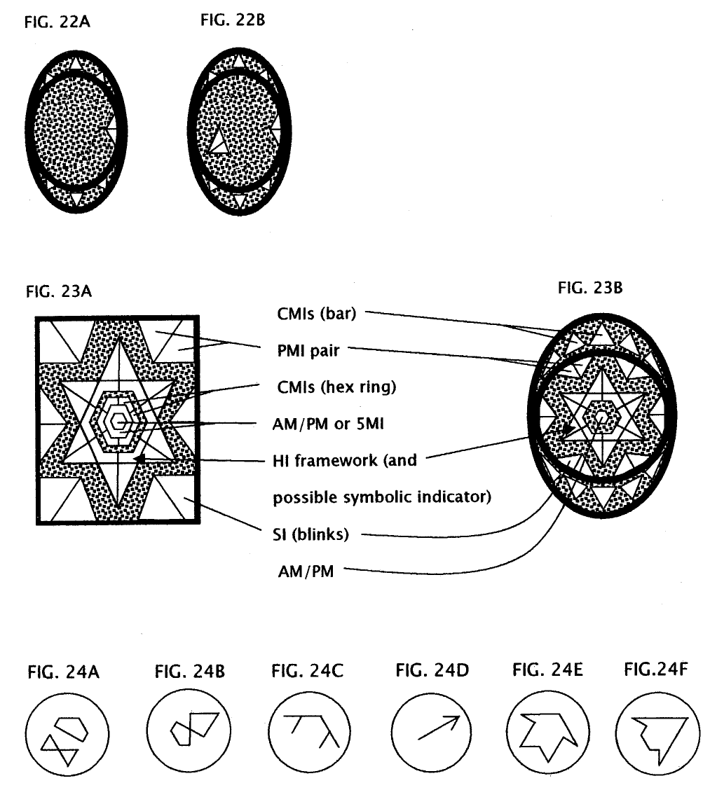

The system may be used as a timer. The obvious way to do so its to make some time value, such as 12 o'clock in particular, equivalent to zero. This would certainly be the preferred approach for setting the time function. However, once it is set, there is no need the time remaining operation to follow the same display pattern it would for a timekeeping function. Instead, it could gradually return to the 12 o'clock, or any other initial timer display setting, like a flower unfolding, display by display, or sets of displays by displays. The amount of time left would not be indicated by any number equivalent, but rather by the approximate percentage of the initial display setting being illuminated. A variety of balanced patterns, for example, progressively using more displays and/or progressing outward could appear. The PMI displays could be used supplementally, to indicate the percentage of elapsed time more simply. See FIG. 21A, which, using FIG. 2A as an initial setting, is an example of a timer face showing about 2 thirds of the set time having elapsed. The “snowflake” variation, in particular, is suited for such a purpose. FIG. 22B is an example of a snowflake variation that could be used to shoe about one-half of the set time having elapsed.

The display system can also be used in a calendar mode. Calendar values could be indicated simply in correspondence to time values, In other words, August 26^{th} would, as shown at FIG. 22A, appear the same as 8:26. As discussed above, a blinking HI—here actually a Monthly, not Hourly Indicator—or a special set of patterns that use the HI displays could be used to distinguish this mode from the timekeeping mode.

The system could also be used as a CD track indicator. For such a purpose, the HI displays would not be necessary at all. See an example that may be used to indicate CD track 26 at FIG. 22B.

Customized Operational Variations—All Claims

The foregoing variations can, to a large extent, be customized. Timepieces could include a button or other means by which various options, such as PMI modifications, or hourly indicator patterns could be selected by the user. Or, more simply, the user could select between an operational mode in which a variety of HIs appear or in which there is not a variety but a standard set that varies only, perhaps, in its AM and PM H's.

Conclusion

In its timekeeping mode, the present invention utilizes the digital process not to create digits, but appealing directional or symbolic images to indicate the hour. It uses the analogue positioning in connection with this digital process. With respect to primary minutes, it uses analogue positioning alone. With respect to complementary minutes, it uses displays that are neither analogue or digital. From these innovations emerges a system that exploits the relatively low production costs and relative multi-functionality of electronic display systems yet creates the images with the intuitive appeal of analogue systems, and, furthermore, creates a variety of images that are not possible either the digital or analogue systems. From these innovations, in other words, emerges a system that, while creating what is found in neither, at the same time combines much of what is best in both the analogue and the digital systems.

I claim the following, examples of which are shown in fig sets 1 to 10, generally respectively:

1. A system of electronic displays, or their functional equivalent, for denoting time and other values and comprising of:
(a) a framework of displays for indicating hourly and other values that, in the aggregate, form the image of a six-pointed star that is bisected through each of its three pairs of opposite points, and which the point section displays appear separate from central area displays of the star image by lines or displays that serve to form a hexagon or similar figure whose points converge with the intersection of the sides of the point displays with the sides of abutting point displays, and
(b) a framework of displays for indicating minute, second and other values that consists of 6 pairs of equal or unequal displays, that, if superimposed upon a traditional analogue timepiece dial face, would appear near the perimeter, all within a single 10-minute analogue minute time span,
and which the display elements of (a) and (b) are displayed selectively in order to denote time and other values.

2. A system described in claim 1, wherein a non-display area in the shape of or similar to a hexagon appears inside the six points of the indicator framework described in claim 1 (a) so that, depending on the size and the posture of the area, sections in claim 1 are altered in shape, size and/or number.

3. A system described in claim 2, further including a central hexagonal ring or figure or similar shaped element that appears in the center of the central display framework created in claim 2 and is displayed selectively to indicate AM or PM or other values.

4. A system described in claim 1, further including an additional 10, 9, 5 or 4 displays that appear within a separate area that abuts or is visually near the area in which the displays of claim 1 appear and which these additional displays are displayed selectively in conjunction with other displays of claim 1 to indicate minute and other values.

5. A system described in claim 2, and further including the additional display elements described in claim 4.

6. A system described in claim 3, further including the additional display elements described in claim 4.

7. A system described in claim 2, further including 6 or 6 pairs of display elements that form a hexagonal ring or similar shaped figure that appears centrally in the area described in claim 2 and which elements are displayed selectively in conjunction with the displays of claim 2 to indicate minute and other values.

8. A system described in claim 7, further including an additional single display ring or figure that appears centrally within or around the display elements described in claim 7, and which is displayed selectively in conjunction with other displays to indicate minute and other values.

9. A system described in claim 3, further including the hexagonal ring or similar shaped figure described in claim 7.

10. A system described in claim 9, further including the single display element ring or figure described in claim 8.

11. A system described in claim 1, further including 6 additional displays that appear within or near the parameters of the displays described in part (b) of claim 1 and which are displayed selectively in conjunction with other displays of claim 1 to indicate minute and other values.

12. A system described in claim 2, further including the 6 additional displays described in claim 11.

13. A system described in claim 3, further including the 6 additional displays described in claim 11.

14. A system described in claim 4, wherein the display pairs described in part (b) of incorporated claim 1 are instead single displays.

15. A system described in claim 5, wherein the display pairs described in part (b) of incorporated claim 1 are instead single displays.

16. A system described in claim 6, wherein the display pairs described in part (b) of incorporated claim 1 are instead single displays.

17. A system described in claim 8, wherein the display pairs described in part (b) of incorporated claim 1 are instead single displays.

18. A system described in claim 10, wherein the display pairs described in part (b) of incorporated claim 1 are instead single displays.

19. A system described in claim 12, wherein the display pairs described in part (b) of incorporated claim 1 are instead single displays, and further including the display added in claim 8.

20. A system described in claim 13, wherein the display pairs described in part (b) of incorporated claim 1 are instead single displays, and further including the display added in claim 8.
